(19) United States
(12) Patent Application Publication
(10) Pub. No.: US 2026/0346807 A1
(43) Pub. Date: Nov. 5, 2026

(54) VEHICLE CURTAIN AIRBAG APPARATUS

(71) Applicant: HYUNDAI MOBIS CO., LTD., Seoul (KR)

(72) Inventor: Geon Woong MOON, Yongin-si (KR)

(73) Assignee: HYUNDAI MOBIS CO., LTD., Seoul (KR)

(21) Appl. No.: 19/532,736

(22) Filed: Feb. 6, 2026

(30) Foreign Application Priority Data
Apr. 30, 2025 (KR) 10-2025-0056898

(51) Int. Cl. B60R 21/2338; B60R 21/232; B60R 21/237

(52) U.S. Cl. CPC B60R 21/2338; B60R 21/232; B60R 21/237; B60R 2021/23386

(57) ABSTRACT

The present invention relates to a vehicle curtain airbag apparatus improved such that deployment of an airbag cushion is not delayed so as to quickly form a shape for protecting a passenger sitting in a third row area. The vehicle curtain airbag apparatus includes an airbag cushion which is installed on a side portion of a vehicle and includes an active area which is configured to be inflated when gas is introduced thereto and a non-active area configured such that the gas is not introduced thereto and a control tether coupled to the airbag cushion, wherein the control tether passes through the airbag cushion at least two times from an outside of the active area of the airbag cushion and surrounds a portion of the airbag cushion.

### CROSS-REFERENCE TO RELATED APPLICATIONS

This application claims priority to and the benefit of Korean Patent Application No. 10-2025-0056898, filed on Apr. 30, 2025, the disclosure of which is incorporated herein by reference in its entirety.

### TECHNICAL FIELD

The present invention relates to a vehicle curtain airbag apparatus.

### BACKGROUND

Recently, as a vehicle becomes larger, a length of an airbag cushion increases. For example, in a vehicle for accommodating multiple passengers (for example, a vehicle for six or more passengers), a first row area in which a driver’s seat and a passenger seat are disposed, and a second row area and a third row area disposed behind the first row area may be provided. Accordingly, the airbag cushion has the length for covering a side portion of the third row area.

Such a curtain airbag cushion includes a first chamber, a second chamber, and a third chamber to cover a first raw area, a second raw area, and a third raw area of a vehicle, and the first chamber, the second chamber, and the third chamber are sequentially disposed in a longitudinal direction (a direction from an engine room toward a passenger room). In this case, in order for the airbag cushion to be stored in the vehicle, the third chamber is primarily folded toward the second chamber, and the primarily folded airbag cushion is rolled and secondarily folded in a direction intersecting a direction in which the third chamber is primarily folded. In this case, when the third chamber is primarily folded, the third chamber may be folded toward a door glass attached to a door of the vehicle.

Accordingly, two unfolding processes are performed to deploy the conventional airbag cushion having the above-described structure. More specifically, a first unfolding process of unfolding the airbag cushion by rolling a third chamber in a direction from a ceiling surface toward a bottom surface of a passenger room and a second unfolding process of unfolding the airbag cushion by rolling the third chamber after the first unfolding process is completed are performed.

Meanwhile, in a vehicle, there are trims which cover pillars constituting a frame of the vehicle. The trims may include a front pillar trim disposed in the first row area, a center pillar trim disposed in the second row area, and a rear pillar trim disposed in the third row area. Each of the trims has a shape protruding toward an inner portion of the passenger room in a width direction (a direction from the driver’s seat toward the passenger seat or a direction opposite thereto) intersecting the longitudinal direction.

Such a trim may cause a problem of interfering with deployment when the airbag cushion deploys. More specifically, the third chamber which deploys later than the other chambers may come into contact with a side portion of the rear pillar trim. This may cause a delay in deployment of the third chamber, and thus a problem that deployment is not performed within a time range intended during a design process may occur.

Accordingly, in order to quickly form a shape for protecting a passenger sitting in a third row area, there is a growing need for research to prevent delayed deployment of an airbag cushion.

### SUMMARY

One embodiment of the present invention is directed to providing a vehicle curtain airbag apparatus improved such that deployment of an airbag cushion is not delayed so as to quickly form a shape for protecting a passenger sitting in a third row area.

According to an aspect of the present invention, there is provided a vehicle curtain airbag apparatus including an airbag cushion which is installed on a side portion of a vehicle and includes an active area which is inflated by gas and a non-active area into which the gas is not introduced and a control tether coupled to the airbag cushion, wherein the control tether passes through the airbag cushion at least two times from an outside of the active area of the airbag cushion and surrounds a portion of the airbag cushion.

The control tether may surround the portion of the airbag cushion from the outside of the active area of the airbag cushion and may be in contact with and coupled to itself at an outer area of the airbag cushion.

The airbag cushion may include a first panel which comes into contact with a passenger and a second panel which is coupled to the first panel and does not come into contact with the passenger, wherein a first chamber area, a second chamber area, and a third chamber area may be formed in the airbag cushion, and when the third chamber area is folded, the control tether may be disposed to face the first panel of the airbag cushion.

The airbag cushion may include a first bonding portion which forms the active area and a boundary between the active area and the non-active area, a plurality of second bonding portions which are installed inside the first bonding portion and form a shape of the active area, a first slit disposed between the first bonding portion and an end portion of the first panel and between the first bonding portion and an end portion of the second panel, and a second slit disposed between the first bonding portion and the first slit.

The first chamber area, the second chamber area, and the third chamber area may be formed in the airbag cushion, and in a state in which the third chamber area is folded, the control tether may be fixed to the first panel of the airbag cushion.

The control tether may pass through the first slit, be disposed to face the second panel, pass through the second slit, and be disposed to face the first panel.

In the state in which the third chamber area is folded, the control tether may be disposed between a folded portion and an unfolded portion of the first panel.

When a folded portion of the airbag cushion is unfolded, the first slit and the second slit of the airbag cushion may be ruptured.

In addition, according to another aspect of the present invention, there is provided a vehicle curtain airbag apparatus including an airbag cushion which includes a first panel configured to come into contact with a passenger and a second panel which is coupled to the first panel and does not come into contact with the passenger and of which portions are bonded to form an active area inflated by gas and a non-active area into which the gas is not introduced and a control tether coupled to the airbag cushion, wherein the control tether forms a ring by passing through the first panel and the second panel of the airbag cushion, and when the airbag cushion is unfolded, an outer area of the active area of the airbag cushion is ruptured by the ring of the control tether.

The airbag cushion may include a first slit disposed between the first panel and an end portion of the second panel at an outside of the active area and a second slit disposed between the active area and the first slit, wherein the ring may be formed after passing through the first slit and the second slit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a vehicle curtain airbag apparatus according to one embodiment of the present invention;

FIG. 2 is a view illustrating a first slit and a second slit;

FIG. 3A is a bottom view illustrating a control tether which passes through the first slit;

FIG. 3B is a bottom view illustrating the control tether passing through the first slit passes through the second slit;

FIG. 3C is a bottom view illustrating the control tether passing through the second slit and is coupled to itself;

FIG. 3D is a front bottom view illustrating the control tether passing through the second slit is coupled to itself;

FIG. 4 is a front view illustrating a folded third chamber area of an airbag cushion;

FIG. 5 is a bottom view illustrating the folded third chamber area of the airbag cushion;

FIG. 6 is a front view illustrating the unfolded third chamber area of the airbag cushion; and

FIG. 7 is a bottom view illustrating the unfolded third chamber area of the airbag cushion.

### DETAILED DESCRIPTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination of a plurality of associated listed items.

When a first element is referred to as being “connected” or “coupled” to a second element, it will be understood that the first element may be directly connected or coupled to the second element, or a third element may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are formed in indirect contact with each other with one or more other elements interposed between the two elements. In addition, when one element is described as being formed on or under the other element, such a description may include a case in which the one element is formed at an upper side or a lower side with respect to the other element.

Terminology used herein is to describe particular embodiments only and is not intended to limit the present invention. The singular forms are intended to include the plural forms unless the context clearly indicates otherwise. In the present specification, it should be further understood that the terms “comprise,” “comprising,” “include,” and/or “including” used herein specify the presence of stated features, numbers, steps, operations, components, parts, or combinations thereof but do not preclude the presence or addition of one or more other features, numbers, steps, operations, components, parts or combinations thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined herein.

Hereinafter, when a vehicle curtain airbag apparatus is described in detail with reference to the accompanying drawings, components that are the same or correspond to each other will be denoted by the same reference numerals in all drawings, and redundant descriptions will be omitted.

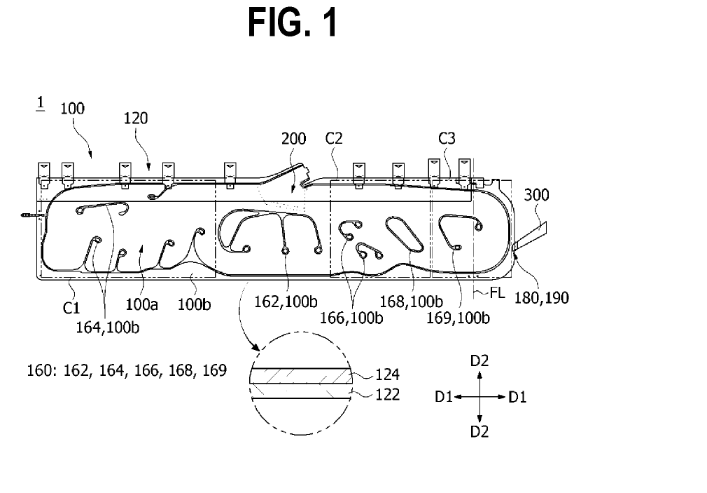

FIG. 1 is a view illustrating a vehicle curtain airbag apparatus according to one embodiment of the present invention.

First, a first direction D1 to be described in the present embodiment is a longitudinal direction, and the longitudinal direction may be a direction from a passenger room (not shown) toward an engine room (not shown) or a direction opposite thereto. In addition, a second direction D2 to be described in the present embodiment is a height direction, and the height direction may be a direction from a ceiling surface toward a bottom surface in the passenger room (not shown) of the vehicle.

Referring to FIG. 1, the vehicle curtain airbag apparatus 1 according to one embodiment of the present invention may be installed in the passenger room of the vehicle. The vehicle curtain airbag apparatus 1 may include an airbag cushion 100, a diffuser 200, and a control tether 300.

The airbag cushion 100 may be installed at a side portion of the vehicle. The airbag cushion 100 may include a first main body 120 and a bonding unit.

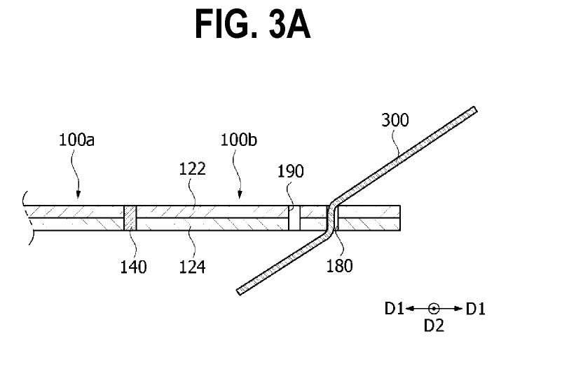

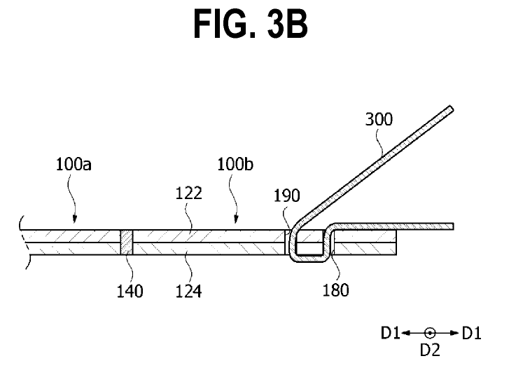

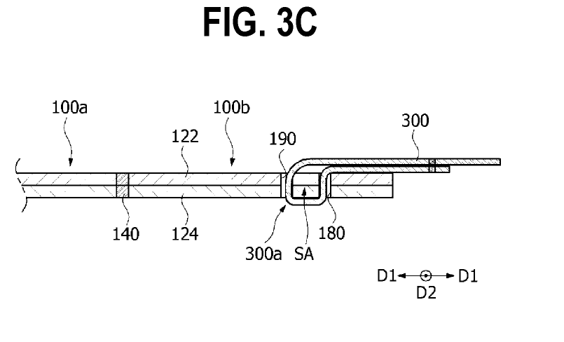

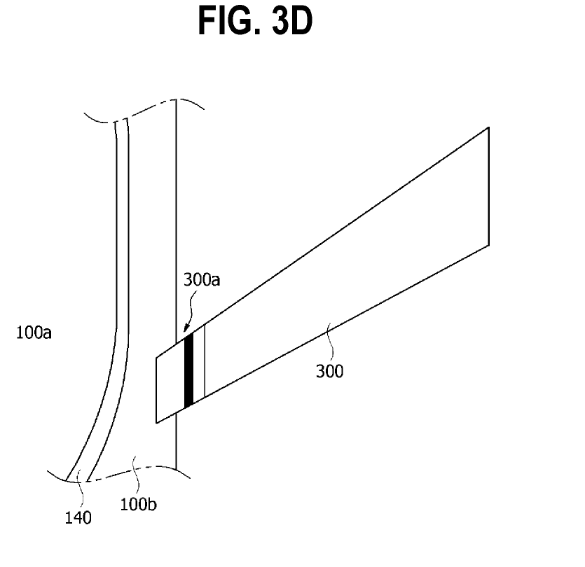

The first main body 120 may form an exterior of the airbag cushion. A first panel 122 and a second panel 124 each having a rectangular shape in which a length in the first direction D1 is greater than a heigh in the second direction D2 may be combined to form the first main body 120 (see FIGS. 3A-3D). The first main body 120 may be disposed in the first direction D1. More specifically, the first panel 122 and the second panel 124 may be coupled to form the first main body 120. The first panel 122 and the second panel 124 may have the same shape.

In this case, the first panel 122 may be a panel to come into contact with a passenger, and the second panel 124 may be a panel which is coupled to the first panel 122 and does not come into contact with the passenger. Accordingly, when the airbag cushion 100 deploys, the first panel 122 may be disposed at a position facing a seat disposed in the passenger room, and the second panel 124 may be disposed at a position facing a door, door glass, door trim, or pillar trim disposed in the passenger room.

An entrance may be formed in the first main body 120. The entrance may be an open portion which is a portion of the first main body 120 to accommodate the diffuser 200 and an inflator (not shown) therein.

The bonding unit may be a set of portions at which the first panel 122 and the second panel 124 are bonded to each other in a state in which the first panel 122 and the second panel 124 of the first main body 120 are disposed to face each other. The bonding unit may include a first bonding portion 140 and a plurality of second bonding portions 160. The bonding unit may be disposed inside an edge of the first main body 120.

The first bonding portion 140 may be disposed along the edge of the first main body 120. Accordingly, the first bonding portion 140 may form an active area 100a in the first main body 120. In this case, the active area 100a may be a portion which is configured to be inflated by gas when the gas generated by the inflator is introduced into the airbag cushion 100. A non-active area 100b may be a portion to which no gas is introduced and hence may not be inflated by the gas due to the first bonding portion 140 and the second bonding portion 160. The first bonding portion 140 may form a boundary between the active area 100a and the non-active area 100b.

The plurality of second bonding portions 160 may be disposed inside the first bonding portion 140. The plurality of second bonding portions 160 may form a shape of the active area 100a in the first bonding portion 140. The plurality of second bonding portions 160 may include a 2-1 bonding portion 162, a 2-2 bonding portion 164, a 2-3 bonding portion 166, a 2-4 bonding portion 168, and a 2-5 bonding portion 169.

The 2-1 bonding portion 162 may be disposed under the diffuser 200 in the second direction D2. The 2-1 bonding portion 162 may be disposed between a first chamber area C1 and a second chamber area C2. In this case, the first chamber area C1 in the first main body 120 may be an area which may come into contact with the body of the passenger sitting in a first row area including a driver’s seat and a spare seat. In this case, the first chamber area C1 may be the area disposed at a left side of the 2-1 bonding portion 162 based on the 2-1 bonding portion 162 in the first direction D1.

The second chamber area C2 in the first main body 120 may be an area which is disposed at a right side of the first row area in the first direction D1 and may come into contact with the body of a passenger sitting in a second row area disposed at the right side of the first row area. That is, the second chamber area C2 may be disposed to be spaced apart from the first chamber area C1 with the 2-1 bonding portion 162 interposed therebetween in the first direction D1.

The third chamber area C3 in the first main body 120 may be an area which is disposed at a right side of the second raw area in the first direction D1 and may come into contact with the body of a passenger sitting in a third raw area disposed at the right side of the second raw area.

The 2-2 bonding portion 164 may be disposed at the left side of the 2-1 bonding portion 162 in the first direction D1. The 2-2 bonding portion 164 may be disposed in the first chamber area C1. The 2-2 bonding portion 164 may be an element forming a shape of the first chamber area C1.

The 2-3 bonding portion 166 may be disposed at a right side of the 2-1 bonding portion 162 in the first direction D1. The 2-3 bonding portion 166 may be disposed in the second chamber area C2. The 2-2 bonding portion 164 may be an element forming the second chamber area C2.

The 2-4 bonding portion 168 may be disposed at a right side of the 2-3 bonding portion 166 in the first direction D1. The 2-4 bonding portion 168 may be disposed in the second chamber area C2. The 2-4 bonding portion 168 may be an element forming the second chamber area C2.

The 2-5 bonding portion 169 may be disposed at a right side of the 2-4 bonding portion 168 in the first direction D1. In addition, the 2-5 bonding portion 169 may be disposed between the 2-4 bonding portion 168 and the first bonding portion 140 in the first direction D1. The 2-5 bonding portion 169 may be disposed in the third chamber area C3. The 2-5 bonding portion 169 may be an element forming the third chamber area C3. In this case, as illustrated in FIG. 1, a boundary between the second chamber area C2 and the third chamber area C3 may be located between the 2-4 bonding portion 168 and the 2-5 bonding portion 169.

The plurality of second bonding portions 160 described above may form a plurality of non-active areas 100b inside the first bonding portion 140. Particularly, the 2-4 bonding portion 168 may be an area to which the control tether 300 is fixed in the plurality of non-active areas 100b.

The diffuser 200 may be coupled to the airbag cushion 100 and may distribute the gas discharged from the inflator such that the gas flows to the first chamber area C1, the second chamber area C2, and the third chamber area C3 of the airbag cushion 100. The diffuser 200 may be disposed in the entrance formed in the first main body 120 of the airbag cushion 100 and accommodate the inflator therein.

The control tether 300 may be coupled to the airbag cushion 100. The control tether 300 may help deployment of the airbag cushion 100 while being unfolded by the gas discharged from the inflator. The control tether 300 may be disposed in the non-active area 100b of the airbag cushion 100 and disposed outside the first bonding portion 140.

The vehicle curtain airbag apparatus 1 may be disposed in the trim of the vehicle through two folding processes and deployed through two unfolding processes to absorb an impact to a passenger when a vehicle collision accident occurs.

First, the airbag cushion 100 may be folded during a primary folding process of folding the third chamber area C3 based on folding line FL illustrated in FIG. 1 in the first direction D1. During the primary folding process, the third chamber area C3 may be folded such that the first panel 122 faces itself based on the folding line FL. After the primary folding process is completed, the airbag cushion 100 may be folded during a secondary folding process. During the secondary folding process, a lower end portion of the airbag cushion 100 may be rolled and folded toward the diffuser 200 in the second direction D2.

Conversely, the airbag cushion 100 may be primarily unfolded while the airbag cushion 100 folded in the second direction D2 during the secondary folding process rolls, and after the primary unfolding is completed, the airbag cushion 100 may be secondarily unfolded as the third chamber area C3 folded during the primary folding process is folded based on the folding line FL. Accordingly, the airbag cushion 100 may deploy completely.

However, during the secondary unfolding process, the third chamber area C3 of the airbag cushion 100 may come into contact with the door glass or pillar trim, and thus deployment is delayed or is not performed. Accordingly, a structure of the present invention for preventing incomplete deployment of the third chamber area C3 will be described below.

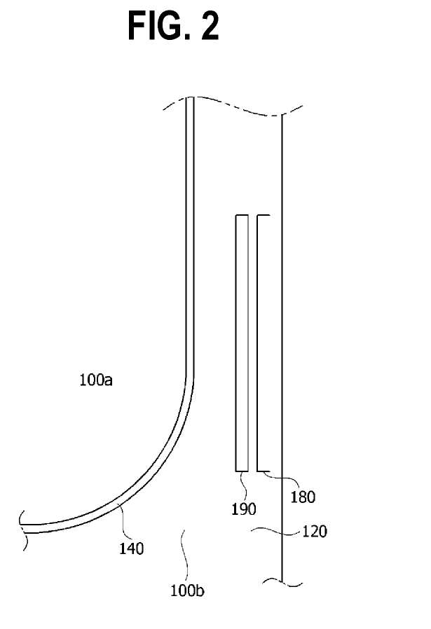

FIG. 2 is a view illustrating a first slit and a second slit.

Referring to FIGS. 1 and 2, the airbag cushion 100 may include a first slit 180 and a second slit 190.

The first slit 180 may be disposed between the first bonding portion 140 of the airbag cushion 100 and an end portion of the first panel 122 and between the first bonding portion 140 and an end portion of the second panel 124. The first slit 180 may have a “⸦” shape. In FIG. 1, the first slit 180 may be formed in a shape in which a portion of an outer side of the first bonding portion 140 in the first main body 120 of the airbag cushion 100 is cut. The portion of the first slit 180 which is not cut may be disposed toward an end portion of the first main body 120 of the airbag cushion 100.

The second slit 190 may be disposed between the first bonding portion 140 and the first slit 180 of the airbag cushion 100. The second slit 190 may have a hole shape passing through the first main body 120. Heights of the first slit 180 and the second slit 190 may be the same in the second direction D2 but are not limited thereto. The heights of the first slit 180 and the second slit 190 may be freely changed according to a shape of the control tether 300.

FIG. 3A is a bottom view illustrating the control tether which passes through the first slit, and FIG. 3B is a bottom view illustrating the control tether passing through the first slit passes through the second slit. FIG. 3C is a bottom view illustrating the control tether passing through the second slit is coupled to itself, and FIG. 3D is a front bottom view illustrating the control tether passing through the second slit is coupled to itself.

Referring to FIGS. 1-3D, the control tether 300 may have a rectangular shape or a shape similar to a rectangular shape. In the present embodiment, the control tether 300 may be formed in a shape having a cross section which is widened from a portion coupled to the airbag cushion 100 toward the outside of the airbag cushion 100 in FIG. 1 but is not limited thereto.

The control tether 300 may be disposed outside the first bonding portion 140 of the airbag cushion 100 which is the outside of the active area 100a of the airbag cushion 100, may pass through the airbag cushion 100 at least two times from the outside of the active area 100a of the airbag cushion 100, and may surround a portion of the airbag cushion 100.

More specifically, as illustrated in FIG. 3A, the control tether 300 may pass through the first slit 180. In this case, the control tether 300 may pass through the first slit 180 to sequentially pass through the first panel 122 and the second panel. Accordingly, a portion of the control tether 300 passing through the first slit 180 may be disposed outside the second panel 124.

Next, as illustrated in FIG. 3B, the portion of the control tether 300 passing through the first slit 180 and disposed outside the second panel 124 may pass through the second slit 190. In this case, the control tether 300 may pass through the second slit 190 to sequentially pass through the second panel 124 and the first panel 122. Accordingly, the control tether 300 may be disposed to face the first panel 122 at the outside of the first panel 122.

The control tether 300 passing through both the first slit 180 and the second slit 190 of the airbag cushion 100 may surround a portion of the airbag cushion 100 from the outside of the active area 100a of the airbag cushion 100 and may be in contact with and coupled to itself at an outer area of the airbag cushion 100. More specifically, as illustrated in FIGS. 3C and 3D, the control tether 300 passing through both the first slit 180 and the second slit 190 of the airbag cushion 100 is folded at a point, at which the control tether 300 has passed through the second slit 190 of the airbag cushion 100, in a state in which the control tether 300 faces itself, and portions facing each other may be fixed through a fixing operation such as sewing. Accordingly, the control tether 300 may form a ring 300a.

The ring 300a may surround a support area SA between the first slit 180 and the second slit 190 of the airbag cushion 100, and when the third chamber area C3 of the airbag cushion 100 is unfolded, the ring 300a may hold the support area SA such that the support area SA between the first slit 180 and the second slit 190 of the airbag cushion 100 does not move along the third chamber area C3.

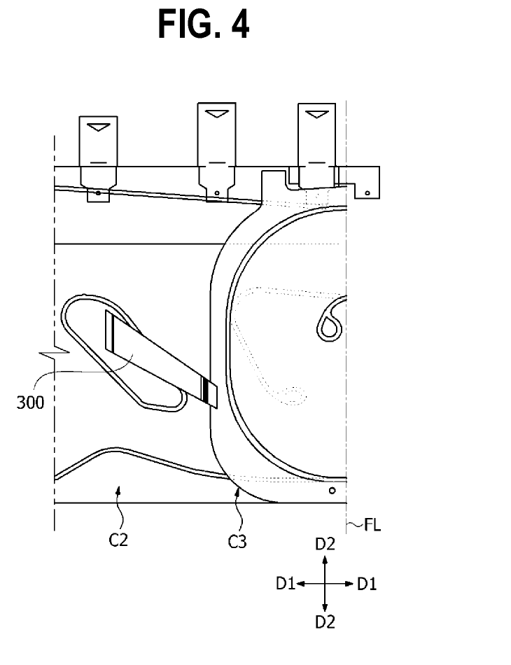

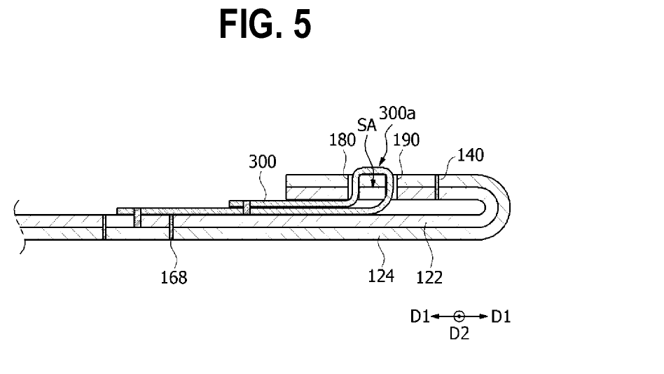

FIG. 4 is a front view illustrating the folded third chamber area of an airbag cushion, and FIG. 5 is a bottom view illustrating the folded third chamber area of the airbag cushion.

Referring to FIGS. 3C, 4, and 5 in a state in which the control tether 300 is coupled to the airbag cushion 100 as described above, the primary folding process of the airbag cushion 100 may be performed. During the primary folding process of the airbag cushion 100, the third chamber area C3 may be folded based on the folding line FL, and the third chamber area C3 may be folded such that the first panel 122 faces itself. In addition, when the third chamber area C3 is folded, the control tether 300 may be disposed to face the first panel 122 of the airbag cushion 100.

In this case, the control tether 300 may be disposed between a folded portion and an unfolded portion of the first panel 122. That is, as the control tether 300 is disposed between the first panel 122, when the third chamber area C3 is unfolded, the ring 300a may pull the support area SA between the first slit 180 and the second slit 190 in the first direction D1 opposite to the first direction D1 which is a direction in which the third chamber area C3 is unfolded. This may be a structure which induces quick rupture of the first slit 180 and the second slit 190.

In addition, as the control tether 300 is disposed between the folded portion and the unfolded portion of the first panel 122, when the third chamber area C3 is unfolded, a phenomenon of delayed deployment of the third chamber area C3 caused by the control tether 300 disposed outside the first panel 122 can be prevented.

Again, referring to FIGS. 3C, 4, and 5, in a state in which the third chamber area C3 is folded, the control tether 300 may be fixed to the first panel 122 of the airbag cushion 100. More specifically, an end portion of the control tether 300 may be disposed on the 2-4 bonding portion 168 of the plurality of second bonding portions 160 of the airbag cushion 100. The end portion of the control tether 300 disposed as described above may be fixed to the 2-4 bonding portion 168 of the airbag cushion 100 through a fixing operation such as sewing. Accordingly, the control tether 300 may connect the 2-4 bonding portion 168 of the airbag cushion 100 and an end portion of the airbag cushion 100.

As described above, a folding process may be completed through the secondary folding process of rolling and folding the third chamber area C3 in the second direction D2 after the primary folding process of folding the third chamber area C3.

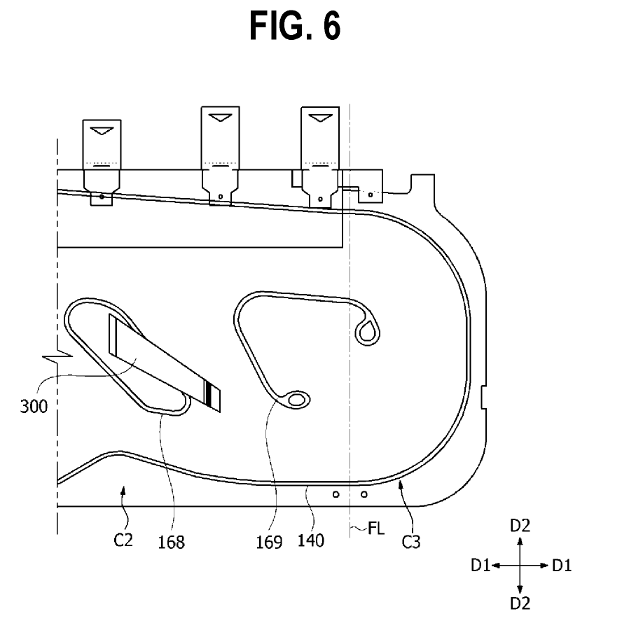

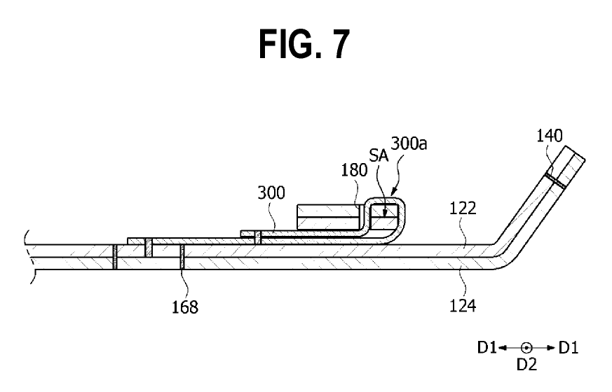

FIG. 6 is a front view illustrating the unfolded third chamber area of the airbag cushion, and FIG. 7 is a bottom view illustrating the unfolded third chamber area of the airbag cushion.

Next, when a vehicle collision accident occurs, the airbag cushion 100 may deploy through the two unfolding processes.

Referring to FIGS. 6 and 7, first, a primary unfolding process of rolling the airbag cushion 100 in the second direction D2 may be performed. Accordingly, the airbag cushion 100 including the folded third chamber area C3 may be rolled in the second direction D2.

Then, a secondary unfolding process of unfolding the third chamber area C3 of the airbag cushion 100 in the first direction D1 may be performed. More specifically, a force is applied the third chamber area C3 such that the third chamber area C3 is rotated about a folded portion thereof while the gas is introduced into the folded third chamber area C3 after the primary unfolding process is completed. In this case, the ring 300a of the control tether 300 holds the support area SA between the first slit 180 and the second slit 190 of the airbag cushion 100. Accordingly, a state, in which the support area SA is fixed by the control tether 300 and disposed in the ring 300a of the control tether 300 without moving to be folded along the third chamber area C3, is maintained.

In this case, since the third chamber area C3 is unfolded continuously, the first slit 180 and the second slit 190 of the airbag cushion 100 may be ruptured by a force generated by unfolding of the third chamber area C3 and separated from the airbag cushion 100 as in FIG. 7. As describe above, when the third chamber area C3 is unfolded, the airbag cushion 100 may deploy completely.

As described above, in the vehicle curtain airbag apparatus 1 according to one embodiment of the present invention, the slits 180 and 190 and the control tether 300 of the airbag cushion 100 can prevent the third chamber area C3 of the airbag cushion 100 which deploys through the secondary unfolding process from being directed toward the door glass or pillar trim while the third chamber area C3 deploys. Accordingly, since deployment of the third chamber area C3 is improved compared to that of the conventional curtain airbag apparatus, the airbag cushion 100 may deploy according to intention of a manufacturing process. Accordingly, injury to the passenger due to deployment failed or delayed deployment can be prevented.

According to one embodiment of the present invention, a slit and a control tether of an airbag cushion can prevent a third chamber area of the airbag cushion, which deploys during a secondary unfolding process, from being directed toward a door glass or pillar trim. Accordingly, since deployment of the third chamber area is improved compared to the conventional curtain airbag apparatus, the airbag cushion can deploy according to intention in a manufacturing process. Accordingly, an injury to a passenger due to failed or delayed deployment can be prevented.

While the present invention has been described above with reference to embodiments of the present invention, it may be understood by those skilled in the art that various modifications and changes of the present invention may be made within a range not departing from the spirit and scope of the present invention defined by the appended claims. In addition, it should be interpreted that differences related to modifications and changes fall within the scope of the present invention defined by the appended claims.

What is claimed is:

1. A vehicle curtain airbag apparatus comprising:
an airbag cushion which is installed on a side portion of a vehicle and includes an active area which is configured to be inflated when gas is introduced thereto and a non-active area configured such that no gas is introduced thereto; and
a control tether coupled to the airbag cushion,
wherein the control tether passes through the airbag cushion at least two times from an outside of the active area of the airbag cushion and surrounds a portion of the airbag cushion.

2. The vehicle curtain airbag apparatus of claim 1, wherein the control tether surrounds the portion of the airbag cushion from the outside of the active area of the airbag cushion and is in contact with and coupled to itself at an outer area of the airbag cushion.

3. The vehicle curtain airbag apparatus of claim 1, wherein the airbag cushion includes:
a first panel configured to come into contact with a passenger; and
a second panel coupled to the first panel and configured not to come into contact with the passenger,
wherein a first chamber area, a second chamber area, and a third chamber area are formed in the airbag cushion, and
wherein, when the third chamber area is folded, the control tether faces the first panel of the airbag cushion.

4. The vehicle curtain airbag apparatus of claim 3, wherein the airbag cushion includes:
a first bonding portion which forms the active area and a boundary between the active area and the non-active area;
a plurality of second bonding portions which are installed inside the first bonding portion and form a shape of the active area;
a first slit disposed between the first bonding portion and an end portion of the first panel and between the first bonding portion and an end portion of the second panel; and
a second slit disposed between the first bonding portion and the first slit.

5. The vehicle curtain airbag apparatus of claim 4, wherein:
the first chamber area, the second chamber area, and the third chamber area are formed in the airbag cushion; and
in a state in which the third chamber area is folded, the control tether is fixed to the first panel of the airbag cushion.

6. The vehicle curtain airbag apparatus of claim 4, wherein the control tether passes through the first slit, faces the second panel, passes through the second slit, and faces the first panel.

7. The vehicle curtain airbag apparatus of claim 5, wherein, in the state in which the third chamber area is folded, the control tether is disposed between a folded portion and an unfolded portion of the first panel.

8. The vehicle curtain airbag apparatus of claim 4, wherein, when a folded portion of the airbag cushion is unfolded, the first slit and the second slit of the airbag cushion are ruptured.

9. A vehicle curtain airbag apparatus comprising:
an airbag cushion which includes a first panel configured to come into contact with a passenger and a second panel coupled to the first panel and configured not to come into contact with the passenger, wherein portions of the airbag cushion are bonded to form an active area configured to be inflated when gas is introduced thereto and a non-active area configured such that no gas is introduced thereto; and
a control tether coupled to the airbag cushion,
wherein the control tether forms a ring by passing through the first panel and the second panel of the airbag cushion, and
wherein, when the airbag cushion is unfolded, an outer area of the active area of the airbag cushion is ruptured by the ring of the control tether.

10. The vehicle curtain airbag apparatus of claim 9, wherein the airbag cushion includes:
a first slit disposed between the first panel and an end portion of the second panel at an outside of the active area; and
a second slit disposed between the active area and the first slit,
wherein the ring is formed after passing through the first slit and the second slit.
